(19) United States
(12) Patent Application Publication
(10) Pub. No.: US 2007/0173634 A1
(43) Pub. Date: Jul. 26, 2007

(54) Methods for one-step purification of organic polymers using tangential flow filtration

(76) Inventors: Nils U. Olsson, San Diego, CA (US); Keith W. Chapman, San Diego, CA (US); Jerod Wooldridge, Oregon, WI (US); Robert M. Winslow, La Jolla, CA (US)

Correspondence Address: GORDON & REES LLP, 101 WEST BROADWAY, SUITE 1600, SAN DIEGO, CA, 92101, US

(21) Appl. No.: 11/339,239

(22) Filed: Jan. 24, 2006

(51) Int. Cl. C08F 6/00

(52) U.S. Cl. 528/480

(57) ABSTRACT

The present invention relates generally to methods for one-step purification of organic polymers using tangential flow filtration. In one embodiment, the present invention relates to methods for size fractionation of heterogeneous organic polymers, such as poly(ethylene glycol) derivatives, using tangential flow filtration. The present invention also relates to purification of low molecular weight monofunctional organic polymer derivatives produced by procedures in which high molecular weight bifunctional poly(ethylene glycol) impurities are removed. The present invention further relates to purification of high molecular weight branched polymer products from low molecular weight starting materials.

### TECHNICAL FIELD

The present invention relates generally to methods for one-step purification of organic polymers using tangential flow filtration. In one embodiment, the present invention relates to methods for size fractionation of heterogeneous organic polymers, such as poly(ethylene glycol) derivatives, using tangential flow filtration. The present invention also relates to purification of low molecular weight monofunctional organic polymer derivatives produced by procedures in which high molecular weight impurities are removed. The present invention further relates to purification of high molecular weight branched polymer products from low molecular weight starting and intermediate materials.

### BACKGROUND OF THE INVENTION

Poly(ethylene glycol) (“PEG”) has been successfully used to improve the pharmacological properties of therapeutic peptides and proteins. “PEGylation,” which refers to the chemical attachment of PEG to therapeutic proteins, can increase protein solubility and stability, prevent rapid renal clearance, and thus increase bioavailability and improve efficacy. The hydrophilic polymeric coating achieved by PEGylation can also improve the safety profile, reducing toxicity and decreasing protein immunogenicity.

Typically, PEGylation is carried out through the reaction of an activated PEG with a functional group on the surface of biomolecules. The most common functional groups are: the amino groups of lysine residues and the N-terminal of proteins; thiol groups of cysteine residues; and the hydroxyl groups of serine, threonine, and tyrosine residue. PEG is usually activated by converting the hydroxyl terminal to a reactive group capable of reacting with these functional groups in a mild aqueous environment. One of the most common PEGs for PEGylation of therapeutic biopharmaceuticals is monofunctional PEGs, such as methoxy-PEG (“mPEG”), which has only one functional group (i.e., hydroxyl), thus minimizing cross-linking and aggregation problems that are associated with bifunctional PEG. However, mPEG is often inherently contaminated with high molecular weight bifunctional PEG (i.e., “PEG diol”) due to its production process, the content of which can range as high as 10 to 15% (Dust, et al., Macromolecule 23: 3742-3746 (1990)). Such bifunctional PEG has roughly twice the size of the desired monofunctional PEG. The contamination problem is further aggravated as the molecular weight of MPEG increases. The purity of MPEG is especially critical for the production of PEGylated biotherapeuticals, which requires a high level of reproducibility of the production processes and quality of the final products as mandated by FDA.

There are several approaches reported in the literature for purification of monofunctional PEG, either before or after the formation of its reactive derivatives. One approach is to convert the hydroxyl group of monofunctional PEG into a carboxylic acid, and then purify this PEG derivative by ion exchange chromatography (U.S. Pat. No. 5,672,662). By using this process, it is possible to remove the di-acid formed from the PEG diol contaminant. However, this approach is very limited and can only be applied to PEG derivatives with charges. Another approach is to chemically modify the hydroxyl group of monofunctional PEG and any contaminating diols using common protecting groups, such as trityl and benzyl groups, and then to separate the protected monofunctional PEG from the impurities by chromatography (U.S. Pat. No. 5,298,410 and PCT WO99/23536). After removal of the protecting groups, the monofunctional PEG derivatives are converted back to monofunctional PEG alcohols. The third approach is to mask the reactive hydroxyl groups without purification. This process requires different starting materials, for example, benzyloxy PEG. The crude benzyloxy PEG with diol impurities is methylated and then hydrogenated to remove the benzyl group to yield mPEG with a terminal hydroxyl group. Since the diol was converted to the inert dimethyl ether and cannot be activated, the mixture can be used directly in the activation and conjugation reactions without further purification. However, all of these processes require multiple steps and involve one or more chemical manipulations. Some even require a relatively dangerous hydrogenation processes. Thus, these processes are laborious and dangerous and have very limited value in commercial production.

Tangential flow filtration (“TFF”) is a convenient method and has been widely used for gross separation of molecules and particles according to their large size differences. Typically, the mass ratio of components to be fractionalized is required to be at least 10, which significantly limits its applications in chemical and biological processes as effective purification tools. The use of TFF in the pharmaceutical field has been reviewed by Genovesi (J. Parenter. Aci. Technol., 37:81, (1983)), including the filtration of sterile water for injection, clarification of a solvent system, and filtration of enzymes from broths and bacterial cultures. Marinaccio, et al. (PCT WO 85/03011) disclose a process for use in the removal of particulate blood components from blood for plasmapheresis, and Robinson, et al. (U.S. Pat. No. 5,423,738) describe the use of TFF for the removal of plasma from blood, allowing the reinfusion of blood cells and platelets into patients. In another use, TFF has been reported for the filtration of beer (European Patent No. 0,208,450), specifically for the removal of particulates such as yeast cells and other suspended solids. Kothe, et al. (U.S. Pat. No. 4,644,056) disclose the use of TFF in the purification of immunoglobulins from milk or colostrum, and Castino (U.S. Pat. No. 4,420,398) describes its use in the separation of antiviral substances, such as interferons, from broths containing these substances as well as viral particles and cells. Similarly, TFF has been used in the separation of bacterial enzymes from cell debris. (Quirk, et al., Enzyme Microb. Technol., 6:201, (1984)). In addition, tangential flow filtration units have been employed in the concentration of cells suspended in culture media. (See, e.g., Radlett, J. Appl. Chem. Biotechnol., 22:495, (1972)). TFF has also been reported to separate liposomes and lipid particles according to size (Lenk, et al., U.S. Pat. No. 5,948,441).

Accordingly, there is need for a general, efficient and economical process to purify monofunctional organic polymers, such as PEG and its derivatives. The present invention provides a general method for the purification of organic polymers based on molecular size by employing tangential flow filtration. This purification method circumvents some of the limitations of earlier approaches and provides a simple and robust method for fractionation of organic polymers based on molecular size. The method of the present invention is easily scalable and involves only one step without any chemical manipulation.

### SUMMARY OF THE INVENTION

The present invention relates generally to methods for one-step purification of organic polymers using tangential flow filtration. In one embodiment, the present invention relates to methods for size fractionation of heterogeneous organic polymers, such as poly(ethylene glycol) derivatives, using tangential flow filtration. The method for separating a heterogeneous mixture of at least two populations of organic polymers from one anther comprising the steps of preparing a solution of the heterogeneous mixture and subjecting the solution to tangential flow filtration to form a retentate and a filtrate. Thus, the two populations are separated from one another, with one population in the retentate and one population in the filtrate. The present invention also relates to purification of low molecular weight monofunctional organic polymer derivatives produced by procedures in which high molecular weight bifunctional poly(ethylene glycol) impurities are removed. The present invention further relates to purification of high molecular weight branched polymer products from low molecular weight starting and intermediate materials.

Other aspects of the invention are described throughout the specification.

### BRIEF DESCRIPTION OF THE DRAWINGS

FIG. 1 illustrates a general set-up for fractionation of polymers using tangential filtration.

FIG. 2 illustrates an analytical HPLC chromatogram of commercially available maleimide-activated methoxy-PEG (i.e., “methoxy-MalPEG”) by size exclusion chromatography. The four small front fractions encompass high molecular weight and/or large size impurities.

FIG. 3 illustrates an analytical HPLC chromatogram of methoxy-MalPEG after being purified with 70 kD tangential flow filtration. The three small front fractions encompass high molecular weight and/or large size impurities.

### DETAILED DESCRIPTION OF THE INVENTION

The present invention relates generally to methods for one-step purification of organic polymers using tangential flow filtration. In one embodiment, the present invention relates to methods for size fractionation of heterogeneous organic polymers, such as poly(ethylene glycol) derivatives, using tangential flow filtration. The present invention also relates to purification of low molecular weight monofunctional organic polymer derivatives produced by procedures in which high molecular weight bifunctional poly(ethylene glycol) impurities are removed. The present invention further relates to purification of high molecular weight branched polymer products from low molecular weight starting and intermediate materials.

To facilitate understanding of the invention set forth in the disclosure that follows, a number of terms are defined below.

Definitions

The term “PEG” refers to poly(ethylene glycol), which is a type of poly(alkylene oxide) (“PAO”). PAOs such as PEG can be linear or branched and have a variety of molecular weights. In its most common form, PEG is a linear molecule containing free hydroxyl groups at each terminus according to Formula (I) as follows:
HO—CH₂CH₂O—(CH₂CH₂O)ₙ—CH₂CH₂—OH (I)
where n is from about 8 to about 4,000.

The term “monofunctional PEG” refers to a PEG molecule, in which one of the terminal functional groups is capped with an essentially inactive group, resulting in only one functional group remaining. A monofunctional PEG with a hydroxyl functional group has a structure according to Formula (II) as follows:
R₁O—(CH₂CH₂O)ₙ—CH₂CH₂—OH (II)
where R₁ is a capping group such as methoxy, ethoxy, and n-propoxy.

The term “heterobifunctional PEG” refers to a PEG that has two different functional groups at each terminus having a structure according to Formula (III) as follows:
X-(CH₂)ₘ—(CH₂CH₂O)ₙ—CH₂CH₂—(CH₂)ₚ-Y (III)
where X and Y are different functional groups as discussed below; n is from about 8 to about 4000, and m and p are integers, usually between 0 to 4.

The term “activated PEG” refers a PEG molecule that has at least one functional group.

The term “methoxy-MalPEG” refers to maleimide activated PEG, which has a maleimide group (1-H-pyrrole-2,5-dione) connected to one terminus either directly or through an optional linker X of various sizes, including, for example, ethyl, propyl, butyl, iso-propyl, pentyl and phenyl groups. A general structure of methoxy-MaIPEG is shown below in Formula (IV) as follows: 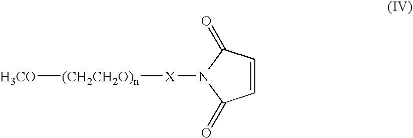
Organic Polymers

The method of the present invention is applicable to fractionalization on the basis of effective molecular size of a variety of amphiphilic polymers, including but not limited to, poly(alkylene oxides) (“PAO”) such as poly(ethylene glycol) (“PEG”) and poly(propylene glycol) (“PPG”), poly(oxyethylated polyol) such as poly(oxyethylated sorbitol) and poly(oxyethylated glucose), poly(olefinic alcohol), poly(vinyl alcohol); polyanaline, polyacrylic, polymaleic, poly(oxazoline), poly(acryloylmorpholine), poly(vinylpyrrolidone)(“PVP”), poly(hydroxypropylmethacrylamide), poly(a-hydroxy acid), and polyphosphazene. The polymers can be homopolymers, or random or block copolymers or terpolymers, based on the monomers of the above polymers. The polymers can also be straight chain or branched. The polymers can have a number of termini, ranging typically from 2 to 300. Although the molecular weight of each chain of the polymer backbone can vary, it is typically in the range of from about 100 Da to about 100,000 Da, often from about 1,000 to about 20,000 Da.

In the present invention, a homogeneous population of a polymer shows only a single peak on an analytical chromatogram, such as, on a size exclusion chromatogram. However, the molecules in the homogenous polymer population can have different molecular weights but within a defined range. A heterogeneous population of polymers, or a heterogeneous mixture of populations of polymers, on the other hand, shows two or more peaks on an analytical chromatogram. To effectively separate two populations, in one aspect, the difference in the effective median molecular weights between the two populations is from about two to about ten fold. Since a polymer is typically prepared through polymerization of one or more types of monomers, the molecules of a homogenous population of a polymer often have the same or similar backbone. The contaminants formed during the polymerization also often have the same or similar backbone as the desired product.

Common processes of polymer syntheses often yield heterogeneous populations of polymers. The difference between individual populations within a heterogeneous mixture is often significant in terms of molecular size ranges when compared to one another. For example, the process for the synthesis of monofuntional PEG generates two different populations of polymers; the desired monofunctional PEG, and contaminating PEG diol, which is about twice the size of the monofunctional PEG. For the simplicity of discussion of the present invention, monofunctional PEG is sometimes referred as the “low molecular weight” population, whereas PEG diol is sometime referred as a “high molecular weight” contaminant. Another example is the synthesis of branched PEG. Branched PEG is commonly prepared by covalently linking two or more linear PEGs together. In this case, the desired product is a “high molecular weight” branched PEG, which contains multiple copies of the linear PEG, and is about twice or more the size of the “low molecular weight” linear PEG. For example, 2,4-bis(methoxy-PEG)-6-chloro-s-triazine is a branched PEG based on a triazine core and contains two linear PEGs (Matsushima, et. al. Chem. Lett. 773-776, (1980)). Another example of branched PEG is synthesized by Yamasaki et. al.(Agric. Biol. Chem. 2125-2127, (1988)) by the attachment of two “low molecular weight” linear PEGs to two amino groups of a lysine. In both above syntheses, the reaction mixture most likely contains two populations of polymers, the “low molecular weight” linear PEG and the “high molecular weight” branched PEG. Accordingly, the desired product in both instances (i.e., formation of a branched product) is about two-fold different than the size of the contaminating products and the starting materials. What we mean by “low” and “high” is that one of the populations has an average molecular weight two or more fold greater (i.e., it has a “high molecular weight”) average molecular weight than the other population (i.e., the “low molecular weight” population).

In one embodiment, the purification method of the present invention can be applied to fractionalize two different populations of PEG from one anther based on different effective median molecule sizes, into two homogeneous populations. However, it should be understood that the method of the present invention can also be used to purify other related polymers, and PEG is used only as an exemplary embodiment. Anyone of skill in the art would understand that the present invention is not so limited. PEG can be in many forms, including alkoxy PEG, bifunctional PEG, multiarmed PEG, forked PEG, branched PEG, pendent PEG (i.e., PEG or related polymers having one or more functional groups pendent to the polymer backbone), or PEG with degradable linkages therein.

In another embodiment, the method of the present invention is applied to fractionalize a heterobifunctional PEG from high molecular weight contaminating homobifunctional PEG to form a more homogeneous “low molecular weight” population, which contains mainly heterobifunctional PEG. The heterobifunctional PEG used in the present invention has the exemplary formula X-(CH₂)ₘ—(CH₂CH₂O)ₙ—CH₂CH₂—(CH₂)ₚ-Y (Formula III), where n is from about 8 to about 4000, m and p are independently zero or positive integers; X and Y are each independently H, alkyl, alkenyl, alkynyl, aryl, heterocyclic, C(O) R₂, COOH, COOR₂, CONR₃R₄, C(O)R₂, OH, OR₂, OC(O)R₂, OC(O)OR₂, OC(O)SR₂, OC(O)N R₃R₄, OSO₂ R₂, OPO₃H₂, OP(H)O₂, OP(H₂)O, OPO₃R₂, OPOR₃R₄, SH, SR₂, SO₃H, S(O)R₂, SO₂NR₃R₄, S(O)₂R₂, NH₂, NHR₂, NR₃R₄, NR₃COR₄, NO₂, PH₃, PH₂R₂, HPO₄, H₂PO₃, H₂PO₂, HPO₄R₂, PO₂R₃R₄, N₃, CN, or a halogen group; R₂, R₃, and R₄ are each independently H, alkyl, alkenyl, alkynyl, aryl, or heterocyclic, or R₃ and R₄ together with the nitrogen to which they are attached can be joined to form a heterocyclic ring. Exemplified functional groups used in PEGylation include, for example, active ester, such as N-hydroxysuccinimydyl carbonates and 1-benzotriazolyl carbonates, acetal, aldehyde, aldehyde hydrate, alkenyl, acrylate, methacrylate, acrylamide, active sulfone, protected amine, protected hydrazide, thiol, protected thiol, carboxylic acid, protected carboxylic acid, isocyanate, isothiocyanate, maleimide, vinylsulfone, dithiopyridine, vynylpyridine, iodoacetamide, epoxide, glyoxals, diones, mesylates, tosylates, tresylate, dichlorotirazine, chlorotriazine, benzotriazole carbonate, p-nitrophenyl carbonate, trichlorophenyl carbonate, carbonylimidazole, and succinimidyl succinate.

In yet another embodiment, the method of the present invention is applied to purify “low molecular weight” monofunctional PEG from “high molecular weight” contaminating bifunctional PEG. Monofunctional PEG has an essentially inactive capping group at one of the two termini. The capping group can be any suitable group known in the art for polymers of this type. One og the most common capping group is a methoxy group. An example of an activated monofunctional methoxy-capped PEG is methoxy-MalPEG.

In yet another embodiment, the method of the present invention can be used to purify “high molecular weight” branched PEG by removing “low molecular weight” linear PEG, or to purify “high molecular weight” PEG with three or more “branches” from less branched intermediates, as long as the ratio of the median molecular weight of the desired “high molecular weight” over the median molecular weight of the intermediates is about two or more.

Tangential Flow Filtration

The sample solution is housed in a tank or other suitable reservoir, and flows tangentially across the surface of a porous membrane at an elevated pressure, which drives permeable components smaller than the pore size of the membrane through the membrane as a “permeate”, while larger component are retained as a “retentate”. Typically, the retentate is recirculated to the tank and pumped across the membrane in a continuous fashion.

Tangential flow filtration of the present invention can be performed using any conventional membrane configuration or membrane-spacer configuration. For example, the membrane can be formed from a hollow membrane fiber, a flat membrane sheet, or a spirally wound membrane sheet.

In a flat plate membrane module, layers of membrane either with or without alternating layers of separator screen are stacked together and then sealed into a package. Feed fluid is pumped into alternating channels at one end of the stack, and the filtrate passes through the membrane into the filtrate channels. Flat plate modules generally have high packing densities and allow linear scaling.

In a spiral wound module, alternating layers of membrane and separator screen are wound around a hollow central core. The feed stream is pumped into one end and flows down the axis of the cartridge. Filtrate passes through the membrane and spirals to the core, where it is removed. The separator screens increase turbulence in the flow path, leading to a higher efficiency module than hollow fibers. One drawback to spiral wound modules is that they are not linearly scaleable, because either the feed flow path length (cartridge length) or the filtrate flow path length (cartridge width) must be changed within scales.

Hollow fiber modules are comprised of a bundle of membrane tubes with narrow diameters, typically in the range of 0.1 to 2.0 mm. In a hollow fiber module, the feed stream is pumped into the lumen (inside) of the tube and filtrate passes through the membrane to the shell side, where it is removed. Because of the very open feed flow path, low shear is generated even with moderate cross-flow rates. While this may be useful for highly shear-sensitive products. In general, it reduces the efficiency of the module by requiring very high pumping capacity to achieve competitive fluxes.

The filters employed in the tangential flow filtration device of the present invention may be chosen from a wide range of organic polymeric filters. Such filters include but are not limited to microporous membranes of nylon, polyvinylidene fluoride (“PVDF”), cellulose acetate/nitrate, polysulfone, polypropylene, and polyamide. Other filters such as ceramic filters and metallic filters may also be used. Membranes having a charged surface, such as those containing carboxyl or sulfonic anionic functional substituents or nylon charged membranes may also be used. Such charged membranes may be used efficiently when polymers are charged. Membranes having an asymmetric structure, such as those used in the processes of reverse osmosis, dialysis, and ultrafiltration may also be used.

The membranes that are best suited for the applications as herein described are those that are resistant to solvents, and those that are amenable to sanitization, or sterilization by techniques such as autoclaving, steam flushing, irradiation, or ethylene oxide exposure. They should be sufficiently hydrophilic or hydrophobic to allow removal of aqueous or organic solvents from the sample. The filters described above are chosen according to the molecular sizes and charges of polymers and contaminants to be removed. For example, the polypropylene and ceramic membranes withstand organic solvents, while the polysulfones and cellulose acetate/nitrate membranes generally do not. Use of such membranes is limited only by the diameter of the products desired, and the availability of the appropriate pore size.

When polypropylene and nylon (hydrophobic) membranes are employed, the best results are obtained when the membranes are wetted with a water-miscible organic solvent, such as ethanol, prior to use. This wetting step may be performed for several minutes by recirculating the solvent through the membrane. The solvent is then removed by the flushing of the membranes with an aqueous solution, such as deionized water or 0.9% saline.

An another important parameter to be considered when selecting a membrane is the molecular weight cutoff. The molecular weight cutoff (“MWCO”) of a membrane is defined by its ability to retain a given percent of a molecule in solution (typically 90% retention). The molecular weight cutoff of a membrane is often correlated well with its pore size but can also be significantly affected by other physical properties, such as the shape, charges, hydrophobicity, and hydrophilicity, of the molecules to be separated and the chemical and physical characteristics of the membrane itself. As such, the membranes employed in tangential flow filtration are typically classified according to molecular weight cutoff rather than pore size.

Often, membranes with different MWCOs can be used in any particular application. The molecular weight cutoff can affect the purity and recovery rate of the desired product as well as the physical and chemical properties, such as, the molecular weight distribution for polymers as typically measured by weight average molecular weight (“Mw”) and/or the number average molecular weight (“Mn”). When the desired product has a lower molecular weight (Mw or Mn) than the contaminating molecule or molecules, the purity of the purified product will typically be increased, whereas the yield will be decreased, as the molecular weight cutoff decreases. Thus, the purified polymeric product will also have an overall lower average molecular weight, as more high molecular weight polymers are eliminated. However, the main peak fraction, centered on a nominal average molecular weight of 5000 Da, will remain largely unaffected. When the desired product has a higher average molecular weight, Mw or Mn, than the contaminating molecule or molecules, the purity of the purified product will typically be increased, whereas the yield will be decreased, as the molecular weight cutoff increases. As a result, the purified polymeric product will also have an overall higher average molecular weight as more lower molecular weight polymers are eliminated. However, the main peak fraction, centered on a nominal average molecular weight of 5000 Da, will remain largely unaffected. The selection of a membrane with a particular molecular weight cutoff depends on the purify requirement for the product in a particular application. In a large-scale production, sometimes, a balance between the purity and the yield has also to be struck in order to provide optimized economical values.

The filtration may proceed at any temperature, to be determined by the temperature restrictions of the polymers used. For example, the process may be performed in the cold at about 4° C. to about 25° C. The sample is circulated through the filtration apparatus by a force, such as by using a pump. Pumps that may be employed include the following types: positive displacement rotary lobe, gear, centrifugal, diaphragm, or peristaltic.

The operating pressure (inlet pressure, which affects the filtration rate) is dependent on a number of variables, such as the volume, viscosity, and composition of the sample, as well as the composition, and surface area of the membrane employed. The operating pressure is generally low on each side of the filter, as is the pressure differential across the filter. In general, when used in the present invention, the maximum psi of hollow fiber film filters (polypropylene, polysulfone, and the like) is about 50 psi, and the ceramic hollow fiber filters is about 150 psi.

In general, in order to increase the separation rate, the flow rate is increased. As the viscosity of the sample increases, or the size of the sample particles approach the size of the filter pore rating, the pressure applied can be less. Pressure parameters are also dependent upon the filter material employed and the sample composition. Finally, if the filter is charged, the charge of the sample passing through (like charge, or opposite charge) may influence the rate at which it flows through the filter (more slowly, or more quickly, respectively), and therefore influences the pump pressure needed. The filter configuration (hollow fiber, tube, or flat sheet) is an additional variable to the pressure setting. Similarly, further considerations, such as the adsorption and/or occlusion of the micropores of the membrane with any of the substituents of the sample may dictate the most efficient rate of filtration. For example, such occlusion may necessitate replacement of the filter following processing of a certain sample volume. Determination of all such processing (e.g., temperature, pressure, filter type) is easily optimized by a person of sill in the art.

The sample is preferably recirculated multiple times (i.e. two or more), the number of circulations being determined by, for example, the volume, viscosity and charge of the sample. For example, as the volume and/or viscosity of the sample is increased, the recirculation time increases. The sample concentration is also determinative of the recirculation time through the filter, and the filtration rate. In a highly viscous preparation, for example, the smaller particles may not reach the filter surface to be eliminated into the filtrate. In such a case, dilution of the feed stock and/or reduction of the recirculation rate may be required. In addition, the recirculation time of the sample may be increased.

As the permeate is collected from the filter, an aqueous or organic solution (such as, for example, sterile buffer or 0.9% saline) may be added to the retentate at the same rate at which permeate is removed in order to maintain the volume. This diafiltration process enhances the yield obtained. In principle, for removal of about 90% of a species (such as, for example, monofunctional PEG) that freely passes through the filter (i.e., a zero rejection coefficient), one can maintain the volume of the retentate while washing with buffer about 2.3 times the volume of the retentate. To remove about 99% of the desired species, the volume of wash through the filter is 4.6 times the retentate volume. Diluted filtrate obtained by this diafiltration process may be concentrated later, using tangential flow filtration. Alternatively, a series of dilutions and concentrations may be used to increase the passage of the species of interest into the filtrate. Alternatively, the entire sample can be recirculated through the filter which would not require addition of aqueous solution.

In addition, two or more tangential flow filtration devices may be connected in series, such as with a pump between the filtration units to provide ample flow for the second filtration, resulting in a polymeric product of specific size separation having upper and lower size limits.

In the present invention, the permeate and/or the retentate can contain the desired products depending on relative median molecular weights of the population of polymer of interest verse the population of the contaminant. For example, in the purification of monofucntional PEG, the permeate is the desired material and contains the “low molecular weight” monofucntional PEG, whereas the retentate contains a population of “high molecular weight” contaminating bifunctional PEG whose median molecular weight is about twice the size of the desired product. On contrary, in the purification of branched PEG, the retentate is the desired fraction and contains the “high molecular weight” more highly branched PEG whereas the permeate contains the less highly branched “low molecular weight” contaminating PEG and starting materials.

Application

Purified organic polymers such as PEG are useful in a variety of biotechnological and pharmaceutical applications. Some functionalized PEGs have been attached to proteins and enzymes with beneficial results. PEG attached to enzymes can result in PEG-enzyme conjugates that are soluble and active in organic solvent, because the PEG is soluble in organic solvents. Attachment of PEG to proteins can prolong their half lives in blood circulation and reduce immunogenicity. PEG attached to surfaces can reduce protein and cell adsorption to a surface, and alter the electrical properties of a surface. Similarly, PEG attached to liposomes can result in a great increase in their blood circulation lifetime and thereby possibly increase their utility for drug delivery.

### EXAMPLE

### Purification of MalPEG Derivative

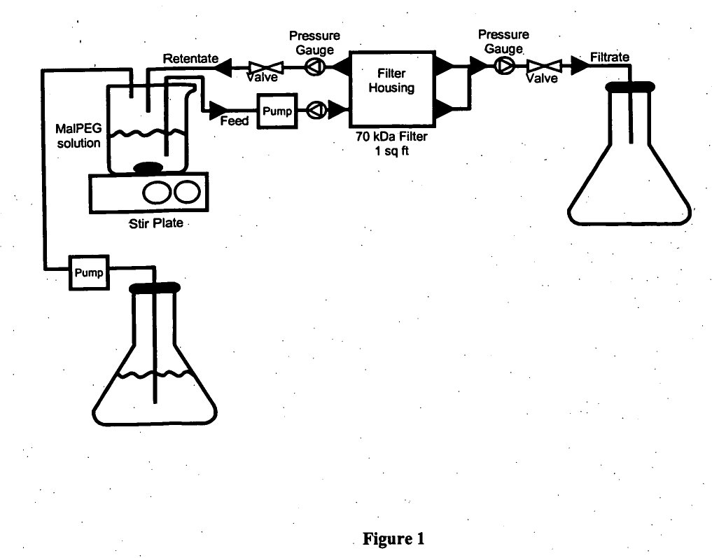

As illustrated in FIG. 1, an exemplary filtration system includes a CENTRAMATE™ filtration cassette by Pall (East Hills, N.Y.), a collecting reservoir, a mixing vessel, a feeding reservoir, and a pump. For purification of MalPEG with a median molecular weight of 5000 Da, three purification experiments were carried out using Poly Ether Sulphone (“PES”) membranes with molecular weight cutoff of 30 kD, 50 kD, and 70 kD, respectively. The CENTRAMATE™ filtration cassette contains a 1 sq.ft. TFF filter in a flat membrane sheet. The system and filter were thoroughly flushed with purified water before processing.

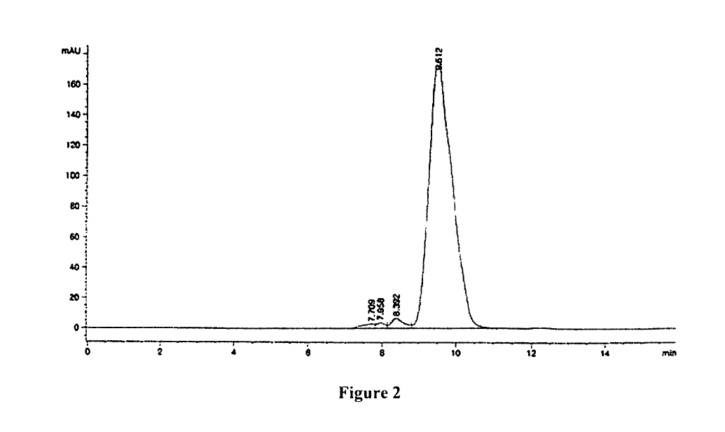

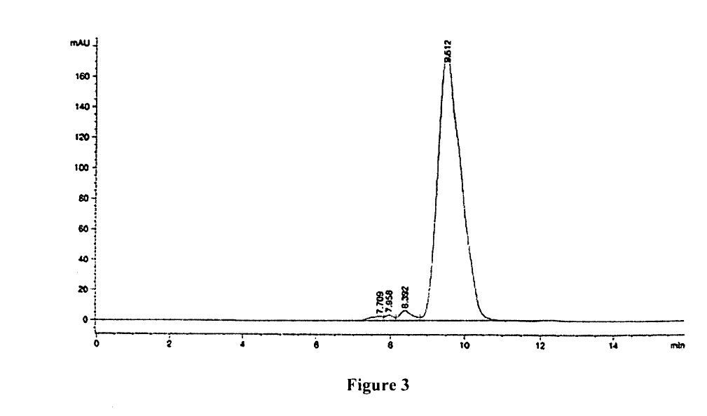

Pure MalPEG is a white crystalline powder. However, commercially available MalPEG often appears as an off-white to light brown powder due to impurities. The more serious problem is that the commercially available MalPEG contains significant amount of high molecular weight bifunctional PEG. As analyzed by HPLC at a wavelength of 280 nm (FIG. 2), the commercially available MalPEG contains 24% impurities. To purify, the commercially available MalPEG was first dissolved in water, 10 mM phosphate buffered saline (“PBS”), or Lactated Ringer's Injection (“RL”), USP (United States Pharmacopeiea) at a concentration of 125 mg/mL with a total volume of approximately 800 mL. The light-brown solution was then pumped through the system at an appropriate flow rate with the filtrate valve close and the retentate valve open. After recirculating for approximately one to five minutes, the filtrate valve was opened and the flow rate was increased to maintain a trans-membrane pressure (“TMP”) between 13 to 16 psi, which is calculated using the following formula: TMP=[(Feed pressure+Retentate pressure)/2]−Filtrate pressure]. The retentate PEG solution was gradually reduced to approximately 500 mL during recirculation. At this point, water, PBS or RL solution was added to maintain a PEG solution feed volume of approximately 500 mL with TMP of about 13 to 16 psi. Diafiltration was continued until ten diavolumes, which was about 5 L, had been added. Diafiltration was then discontinued by stopping the pump and closing the filtrate valve. The filter was rinsed by removing the feed tubing from the PEG solution, inserting it into a vessel containing water, PBS or RL and flushing with at least 200 mL. The rinse solution was pumped slowly through the system until no more solution flowed out of the retentate tubing. The retentate in the feed vessel remained light-brown to brown during the TFF process, whereas the filtrate fractions that were collected became successively lighter in color; from yellow to almost completely clear. The combined filtrate was analyzed by high performance liquid chromatography (“HPLC”) at 20° C. using a Protein KW803, size exclusion column, and monitored at a wavelength of 280 and 413 nm or by refractive index (“RI”) detection. The mobile phase was 10 mM PBS or water/ethanol (95/5, v/v). FIG. 3 shows the profile of the purified product using a membrane with a molecular weight cutoff of 70 kD. The purity of the PEG derivative was increased to 94.3% after purification as determined gravimetrically, with a recovery rate of 99%. After separation, the desired PEG compound is white and no longer brown or off-white.

The examples set forth above are provided to give those of ordinary skill in the art with a complete disclosure and description of how to make and use the preferred embodiments of the compositions, and are not intended to limit the scope of what the inventors regard as their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to he incorporated herein by reference.

What is claimed is:

1. A method for separating a heterogeneous mixture of at least two populations of organic polymers having at least two fold different molecular weight averages from one another comprising the steps of:
a) preparing a solution of the heterogeneous mixture; and
b) subjecting the solution to tangential flow filtration to form a retentate and a filtrate, wherein the two populations are separated from one another, with one population in the retentate and one population in the filtrate.

2. The method of claim 1, wherein the polymer is a synthetic polymer.

3. The method of claim 1, wherein the polymer is PEG which contains at least two populations of polymers.

4. The method of claim 3, wherein the first population contains low molecular weight monofunctional PEGs and the second population contains high molecular weight PEG diols.

5. The method of claim 4, wherein the mono-functional PEG has one terminal group is essentially non-reactive.

6. The method of claim 5, wherein said non-reactive group is an alkoxy group.

7. The method of claim 6, wherein the alkoxy group is methoxy.

8. The method of claim 4, wherein the mono-functional PEG has a hydroxyl group or an activated group.
